(19) United States
(12) Patent Application Publication
(10) Pub. No.: US 2025/0087671 A1
(43) Pub. Date: Mar. 13, 2025

(54) ANODE ACTIVE MATERIAL FOR LITHIUM SECONDARY BATTERY, AND PREPARATION METHOD THEREFOR

(71) Applicant: IUCF-HYU (INDUSTRY-UNIVERSITY COOPERATION FOUNDATION HANYANG UNIVERSITY), Seoul (KR)

(72) Inventors: Hansu KIM, Seoul (KR); Dong Jae CHUNG, Seoul (KR); Won Joon JEONG, Seoul (KR)

(21) Appl. No.: 18/957,918

(22) Filed: Nov. 25, 2024

Related U.S. Application Data
(63) Continuation of application No. PCT/KR2023/007537, filed on Jun. 1, 2023.

(30) Foreign Application Priority Data
Jun. 2, 2022 (KR) 10-2022-0067647

(51) Int. Cl. H01M 4/36; C01B 33/32; H01M 4/02; H01M 4/38; H01M 4/58; H01M 10/052

(52) U.S. Cl. CPC H01M 4/364; C01B 33/32; H01M 4/386; H01M 4/5825; H01M 10/052; C01P 2002/72; C01P 2002/85; C01P 2004/03; C01P 2004/04; C01P 2006/12; C01P 2006/40; H01M 2004/021; H01M 2004/027

(57) ABSTRACT

The present disclosure relates to an anode active material for a lithium secondary battery, and a preparation method therefor. The anode active material of the present disclosure comprises silicon, lithium silicate, and a transition metal-silicon alloy, and thus can significantly improve lifespan properties while maintaining initial efficiency at an excellent level.

### TECHNICAL FIELD

The present disclosure relates to an anode active material for a lithium secondary battery and a method for preparing the same. The anode active material according to the present disclosure includes silicon, lithium silicate and a transition metal-silicon alloy, and thus can alleviate a rapid change in volume of silicon with no drop of initial efficiency to improve life characteristics and can improve high-rate characteristics and high-temperature storage characteristics.

### BACKGROUND ART

Eco-friendly technologies have been increasingly in demand, as environmental issues, such as environmental pollution and global warming, come to the fore and solutions for problems, such as depletion of fossil fuel and an increase in carbon dioxide emission, are required. Particularly, as technological needs for eco-friendly electric vehicles and energy storage systems (ESSs) are increased, lithium secondary batteries have been increasingly in demand as energy storage devices. In line with this trend, active studies have been conducted to increase energy density of lithium secondary batteries and to improve life characteristics of lithium secondary batteries.

Many studies have been conducted as attempts to use metallic materials, such as silicon (Si), tin (Sn) and aluminum (Al), as anode active materials in order to provide high-capacity lithium secondary batteries. Among such metallic materials, silicon (Si) allows reversible lithium intercalation/deintercalation through the reaction of forming a compound with lithium and shows the maximum theoretical capacity of about 4020 mAh/g (9800 mAh/cc, specific gravity 2.23), which is significantly higher than the theoretical maximum capacity of conventional carbonaceous materials. Therefore, silicon is promising as a high-capacity anode material.

However, since silicon may be swollen up to about 300% of its initial volume due to lithium intercalation, it causes a rapid change in volume after the operation of a lithium secondary battery. Such a rapid change in volume may cause not only cracking on the surface of an anode active material but also production of ionic substances inside the anode active material, thereby causing a rapid drop in capacity of a battery and an electrical dissolution phenomenon leading to a significant drop in capacity retention.

In the case of pre-lithiation technology of an anode active material according to the related art, it can improve the initial efficiency of a silicon oxide-based anode active material among the electrochemical characteristics thereof. However, it merely suggests improvement of initial efficiency alone as technological result, and thus is disadvantageous in that improvement of high-rate characteristics and thermal stability is hardly expected from the pre-lithiation of a silicon oxide-based anode active material.

Under these circumstances, the present inventors have found that application of an anode active material including silicon, lithium silicate and a transition metal-silicon alloy to a lithium secondary battery can alleviate a rapid change in volume of silicon with no drop of initial efficiency to improve life characteristics and can improve high-rate characteristics and high-temperature storage characteristics. The present disclosure is based on this finding.

### REFERENCES

### Patent Documents

Patent Document 1. Korean Patent Publication No. 10-228623

### DISCLOSURE

### Technical Problem

The present disclosure is provided to solve the above-mentioned problems. The present disclosure is directed to providing an anode active material which includes silicon, lithium silicate and a transition metal-silicon alloy, alleviates a rapid change in volume of silicon while maintaining initial efficiency at an excellent level when being applied to a lithium secondary battery to improve life characteristics and can improve high-rate characteristics and high-temperature storage characteristics, and a method for preparing the same.

The present disclosure is also directed to providing an anode including the anode active material and showing excellent electrochemical characteristics, and a lithium secondary battery including the same.

### Technical Solution

In one aspect of the present disclosure, there is provided an anode active material including: silicon; lithium silicate; and a transition metal-silicon alloy.

In another aspect of the present disclosure, there is provided an anode including the anode active material.

In still another aspect of the present disclosure, there is provided a lithium secondary battery including the anode.

In yet another aspect of the present disclosure, there is provided a method for preparing an anode active material, including the steps of: (i) mixing silicon monoxide with a transition metal precursor; (ii) heat treating the mixture obtained from step (i) to obtain a transition metal-silicon alloy; and (iii) mixing the mixture obtained from step (ii) with a lithium precursor and carrying out heat treatment to obtain lithium silicate.

### Advantageous Effects

The anode active material according to the present disclosure can improve long-term cycle life characteristics while maintaining high initial efficiency of lithium silicate with no significant drop. In addition, the anode active material can provide improved high-rate characteristics and thermal stability, and thus can increase the scope of utilization of a lithium secondary battery using the same.

### DESCRIPTION OF DRAWINGS

FIG. 1 shows X-ray diffractometry (XRD) results of the anode active materials according to Examples 1 and 2 and Comparative Examples 1 and 2.

FIG. 2 shows a scanning electron microscopic (SEM) image (a) of the section of the anode active material according to Example 1, and energy dispersive spectroscopic (EDS) image of Si (b), Ti (c) and O (d) elements.

FIG. 3 shows a high-resolution transmission electron microscopic (HRTEM) images (a, b) of the anode active material according to Example 1, scanning transmission electron microscopic (STEM) image (c) thereof, and an energy dispersive spectroscopic (EDS) image (d) of Si (blue), Ti (red) and O (green) elements.

FIG. 4 shows the nitrogen gas adsorption test results of the anode active materials according to Examples 1 and 2 and Comparative Examples 1 and 2.

FIG. 5 shows the charge/discharge voltage curve of a secondary battery using the anode active material according to each of Examples 1 and 2 and Comparative Examples 1 and 2.

FIG. 6 shows a graph illustrating the discharge life characteristics of a secondary battery using the anode active material according to each of Examples 1 and 2 and Comparative Examples 1 and 2 after the 500^{th} cycle.

FIG. 7 shows the charge/discharge voltage curve of a secondary battery using the anode active material according to each of Examples 3 and 4.

FIG. 8 shows a graph illustrating the discharge life characteristics of a secondary battery using the anode active material according to each of Examples 3 and 4 after the 200^{th} cycle.

FIG. 9 shows the charge/discharge voltage curve of a secondary battery using the anode active material according to Example 1 as a function of current density.

FIG. 10 shows a graph illustrating the high-rate characteristics of a secondary battery using the anode active material according to each of Example 1 and Comparative Examples 1 and 2.

FIG. 11 shows the charge/discharge voltage curve of a secondary battery using the anode active material according to each of Example 1 and Comparative Examples 1 and 2, before and after storing the battery at high temperature.

### BEST MODE

The advantages and features of the present disclosure and methods of achieving them will become clear with reference to the embodiments described hereinafter in detail with the accompanying drawings. However, the present disclosure is not limited to the embodiments described hereinafter and will be implemented in various different forms, the embodiments described hereinafter are provided only to ensure that the disclosure of the present invention is complete and to fully inform those skilled in the art to which the present disclosure pertains the scope of the present disclosure, and the disclosure is only defined by the scope of the claims.

In the specification, if it is determined that detailed description of a related known technology may unnecessarily obscure the gist of the present disclosure, the detailed description thereof is omitted. If “including”, “having”, “formed of” or the like mentioned in the present specification is used, other parts may be added unless “only” is used. In addition, terms such as “including” or “having” are intended to specify that there is a feature, number, step, element or combination thereof described in the specification, and should not be understood as excluding the existence or the possibility of addition of one or more other features, numbers, steps, elements, or combinations thereof. Further, the case of expressing an element in a singular form includes the case of including the plural unless otherwise stated.

As described above, the anode active material including lithium silicate according to the related art merely improves initial efficiency, hardly alleviates a change in volume caused by volumetric swelling of silicon, and thus provides poor life characteristics. In addition, such an anode active material makes it difficult to expect improvement of high-rate characteristics and high-temperature storage characteristics.

Under these circumstances, according to the present disclosure, there is provided an anode active material including silicon, lithium silicate and a transition metal-silicon alloy, and the anode active material effectively alleviates a rapid change in volume of silicon caused by lithium ion intercalation/deintercalation to enhance life characteristics significantly and improves high-rate characteristics and high-temperature storage characteristics to enhance the utility of a lithium ion battery including the same.

Particularly, in one aspect of the present disclosure, there is provided an anode active material including: silicon (Si); lithium silicate; and a transition metal-silicon alloy.

The anode active material according to the present disclosure is characterized in that it includes all of silicon, lithium silicate and a transition metal-silicon alloy, and thus improves the problems of lithium silicate, including brittleness of lithium silicate and poor electrifying property resulting from oxide nature, while maintaining initial efficiency at the same level as lithium silicate.

The transition metal-silicon alloy may be present inside of lithium silicate. When the transition metal-silicon alloy is not simply mixed with lithium silicate but is present inside the microstructure of lithium silicate, it is possible to improve life characteristics significantly.

Herein, lithium silicate may include at least one of Li₂Si₂O₅, LizSiO₃ and Li₄SiO₄, preferably Li₂SiO₃. Particularly, when lithium silicate includes Li₂SiO₃, there is an advantage in that the initial efficiency of a secondary battery is significantly improved.

The transition metal-silicon alloy has a low specific volume to increase the specific area and porosity of the surface of an anode active material. Therefore, there is provided a sufficient space in which silicon may undergo volumetric swelling in such pores, and thus effectively alleviates a rapid change in volume of silicon during repeated charge/discharge of a lithium secondary battery and improves life characteristics of a lithium secondary battery including the transition metal-silicon alloy. In addition, the transition metal-silicon alloy has high electroconductivity and a large specific surface area to improve high-rate characteristics and inhibits self-discharge caused by high-temperature storage to improve thermal stability.

Lithium silicate may be present in an amount of 65-75 wt %, preferably 67-73 wt % based on 100 wt % of the total weight of the anode active material. When the content of lithium silicate is less than the lower limit, initial efficiency may be decreased. On the other hand, when the content of lithium silicate is larger than the upper limit, the resultant anode active material may provide decreased mechanical strength and undergo cracking after repeating charge/discharge.

The transition metal may include at least one selected from titanium (Ti), iron (Fe), manganese (Mn), nickel (Ni), cobalt (Co), niobium (Nb), zirconium (Zr) and copper (Cu), preferably at least one selected from titanium (Ti), niobium (Nb) and zirconium (Zr).

The transition metal-silicon alloy may be present in an amount of 1.6-10 wt %, preferably 2.3-7 wt %, based on 100 wt % of the total weight of the anode active material. When the content of transition metal-silicon alloy is less than the lower limit, it is difficult to expect an effect of improving life characteristics. On the other hand, when the content of transition metal-silicon alloy is larger than the upper limit, electrochemical performance may be degraded.

The anode active material may have a specific surface area of 4.85-6.69 m²g⁻¹ and a porosity of 0.0302-0.0330 cm³g⁻¹. When the specific surface area and porosity of anode active material do not fall within the above-defined ranges, there is a disadvantage in that rapid volumetric swelling of silicon cannot be alleviated effectively.

In another aspect of the present disclosure, there is provided an anode including the above-described anode active material.

In still another aspect of the present disclosure, there is provided a lithium secondary battery including the anode.

In yet another aspect of the present disclosure, there is provided a method for preparing an anode active material, including the steps of: (i) mixing silicon monoxide with a transition metal precursor; (ii) heat treating the mixture obtained from step (i) to obtain a transition metal-silicon alloy; and (iii) mixing the mixture obtained from step (ii) with a lithium precursor and carrying out heat treatment to obtain lithium silicate.

The method for preparing an anode active material according to the present disclosure is characterized in that silicon monoxide and a transition metal precursor are mixed and heat treated to provide a transition metal-silicon alloy, and then a mixture including the transition metal-silicon alloy and a lithium precursor are mixed and heat treated to provide lithium silicate, thereby providing an anode active material including silicon, a transition metal-silicon alloy and lithium silicate.

If silicon, a transition metal-silicon alloy and lithium silicate are simply mixed to provide an anode active material unlike the present disclosure, the transition metal-silicon alloy is not present in the microstructure of lithium silicate but is simply mixed, unlike the present disclosure. As a result, it is not possible to expect an effect of improving life characteristics.

Hereinafter, each step of the method for preparing an anode active material according to the present disclosure will be explained in more detail.

### (i) Step of Mixing Silicon Monoxide with Transition Metal Precursor

First, silicon monoxide is mixed with a transition metal precursor.

Step (i) includes mixing silicon monoxide with a transition metal precursor. When silicon monoxide is mixed with a transition metal not a transition metal precursor, the transition metal may be aggregated and provide poor dispersibility undesirably.

The transition metal precursor may be at least one of hydrides and hydroxides of transition metals. Use of transition metal hydrides is preferred in that hydrogen evaporates during the subsequent heat treatment to form reductive atmosphere, thereby preventing oxidation.

The transition metal may be at least one selected from titanium (Ti), iron (Fe), manganese (Mn), nickel (Ni), cobalt (Co), niobium (Nb), zirconium (Zr) and copper (Cu), preferably at least one selected from titanium (Ti), niobium (Nb) and zirconium (Zr).

The transition metal precursor and silicon monoxide may be mixed in such a manner that the molar ratio (M/Si) of transition metal (M) to silicon (Si) may be 0.02-1, preferably 0.023-0.07.

Step (i) may be carried out through a mechanical alloying process, particularly through any one process selected from ball milling, attrition milling, high energy milling and jet milling, and most preferably through a ball milling process. When step (i) is carried out through ball milling, there is an advantage in that the transition metal precursor is dispersed homogeneously.

When the mixing in step (i) is carried out through ball milling, the ball milling may be carried out at a rate of 500-1000 rpm for 4-12 hours. When the ball milling rate and time satisfy the above-defined ranges, it is shown that the transition metal precursor and silicon monoxide are dispersed homogeneously while showing a uniform shape and size.

### (ii) Step of Heat Treating Mixture Obtained from Step (i) to Obtain Transition Metal-Silicon Alloy

Next, the mixture obtained from step (i) is heat treated to obtain a transition metal-silicon alloy.

The heat treatment in step (ii) may be carried out at 500-1200° C. for 5 minutes to 3 hours, preferably at 600-1100° C. for 30 minutes to 2 hours, and more preferably at 700-900° C. for 40 minutes to 1.5 hours. When at least one of the heat treatment temperature and time is less than the lower limit, the transition metal-silicon alloy cannot be formed sufficiently. On the other hand, when at least one of the heat treatment temperature and time is larger than the upper limit, an irreversible phase is formed, and thus the initial efficiency of a lithium secondary battery including the same may be degraded.

### (iii) Step of Mixing Mixture Obtained from Step (ii) with Lithium Precursor and Carrying Out Heat Treatment to Obtain Lithium Silicate

Then, the mixture obtained from step (ii) is mixed with a lithium precursor and heat treatment is carried out to obtain lithium silicate.

The lithium precursor may be at least one selected from lithium (Li), lithium hydride (LiH) and lithium hydroxide (LiOH).

The mixture obtained from step (ii) and the lithium precursor may be mixed in such a manner that the molar ratio (Li/Si) of lithium to silicon may be 0.3-1, preferably 0.5-0.7. When the molar ratio of lithium to silicon is less than the lower limit, lithium silicate cannot be formed sufficiently, and thus the electrochemical properties of the resultant anode active material may be degraded. On the other hand, when the molar ratio is larger than the upper limit, the mechanical properties of the resultant anode active material may be degraded, and cracking may occur due to volumetric swelling of silicon (Si).

The heat treatment in step (iii) may be carried out at 600-1000° C. for 1-12 hours, preferably at 600-900° C. for 3-10 hours, and more preferably at 700-800° C. for 5-8 hours. When at least one of the heat treatment temperature and time is less than the lower limit, lithium silicate cannot be formed sufficiently, and thus the electrochemical properties of the resultant anode active material may be degraded undesirably. On the other hand, when at least one of the heat treatment temperature and time is larger than the upper limit, there is a disadvantage in that undesired byproducts may be generated.

Herein, lithium silicate may be present in an amount of 65-75 wt %, preferably 67-73 wt %, based on 100 wt % of the total weight of the anode active material.

The transition metal-silicon alloy may be present in an amount of 1.6-10 wt %, preferably 2.3-7 wt %, based on 100 wt % of the total weight of the anode active material.

The anode active material may have a specific surface area of 4.85-6.69 m²g⁻¹ and a porosity of 0.0302-0.0330 cm³g⁻¹.

According to the most preferred embodiment of the present disclosure, the transition metal precursor may be titanium hydride (TiH2), the transition metal precursor and silicon monoxide may be mixed in such a manner that the molar ratio (M/Si) of the transition metal to silicon may be 0.023-0.07, the mixing in step (i) may be carried out through ball milling at a rate of 500-1000 rpm for 4-12 hours, the heat treatment in step (ii) may be carried out at 700-900° C. for 40 minutes to 1.5 hours, the lithium precursor may be lithium hydride (LiH), the mixture obtained from step (ii) and the lithium precursor may be mixed in such a manner that the molar ratio (Li/Si) of lithium to silicon may be 0.5-0.7, the heat treatment in step (iii) may be carried out at 700-800° C. for 5-8 hours, the transition metal-silicon alloy may be present in an amount of 2.3-7 wt % based on 100 wt % of the total weight of the anode active material, lithium silicate may be present in an amount of 67-73 wt % based on 100 wt % of the total weight of the anode active material, and the anode active material may have a specific surface area of 4.85-6.69 m²g⁻¹ and a porosity of 0.0302-0.0330 cm³g⁻¹.

When the method for preparing an anode active material according to the present disclosure satisfy all of the conditions of the most preferred embodiment, no constitutional elements of the electrode are lost or separated, and the battery shows excellent life characteristics even after repeating 100 charge/discharge cycles at a high temperature (85° C.), as determined by carrying out surface analysis through scanning electron microscopy (SEM).

However, any one of the conditions of the most preferred embodiment is not satisfied, it is observed that the constitutional elements of the electrode are lost partially, and the battery shows degraded life characteristics.

Examples will be described more fully hereinafter so that the present disclosure can be understood with ease. The following examples may, however, be embodied in many different forms and should not be construed as limited to the exemplary embodiments set forth therein. Rather, these exemplary embodiments are provided so that the present disclosure may be explained more fully to those skilled in the art.

### Example 1

First, 5 g of silicon monoxide powder, 0.141 g of titanium hydride (TiH₂) and iron balls were introduced to a stainless steel vial, and the vial was filled with argon gas to carry out a ball milling process at a rate of 800 rpm for 8 hours under inert atmosphere. Herein, the molar ratio of Ti/Si was 0.025. After carrying out the ball milling process, the resultant powder was introduced to an alumina crucible, and heat treatment was carried out at 800° C. for 1 hour under argon atmosphere by using a vertical furnace.

The powder obtained from the heat treatment and lithium hydride (LiH) powder were introduced to a sealed container together with zirconia balls (10 times of the mixed powder), and then shaken and mixed for 30 minutes by using a shaker. Herein, the molar ratio of Li/Si was 0.67. Then, the mixed powder was introduced to an alumina crucible, and heat treatment was carried out at 750° C. for 6 hours under argon atmosphere by using a vertical furnace. After that, the heat-treated powder was recovered and pulverized in a mortar to obtain a lithium-doped silicon anode active material containing a Ti—Si alloy.

### Example 2

An anode active material was obtained in the same manner as Example 1, except that 0.282 g of TiH₂ was used so that the molar ratio of Ti/Si might be 0.05.

### Example 3

An anode active material was obtained in the same manner as Example 1, except that NbH₂ was used instead of TiH₂.

### Example 4

An anode active material was obtained in the same manner as Example 1, except that ZrH₂ was used instead of TiH₂.

### Comparative Example 1

Silicon monoxide powder was used.

### Comparative Example 2

### Preparation of Lithium-Doped Silicon Oxide

A lithium-doped silicon oxide anode active material was obtained in the same manner as Example 1, except that no treatment with TiH₂ was carried out.

### Test Example 1

### X-Ray Diffractometry (XRD)

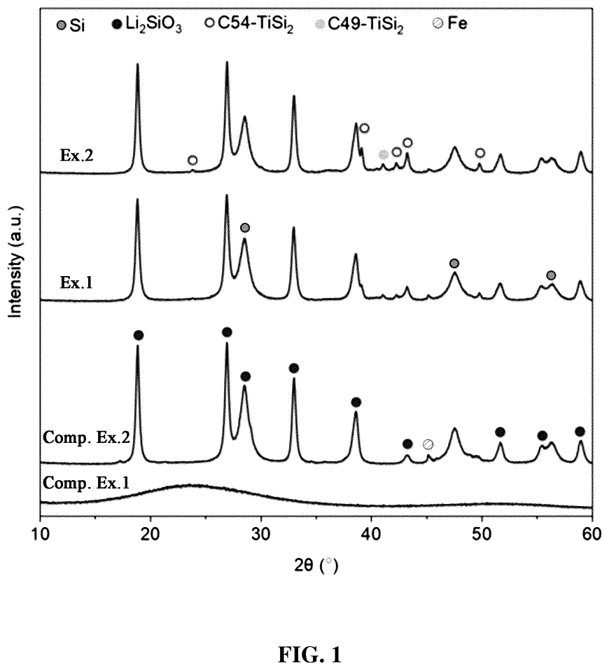

The anode active material according to each of Examples 1 and 2 and Comparative Examples 1 and 2 was analyzed through X-ray diffractometry (XRD). The results are shown in FIG. 1.

FIG. 1 shows X-ray diffractometry (XRD) results of the anode active materials according to Examples 1 and 2 and Comparative Examples 1 and 2.

Referring to FIG. 1, the anode active material according to Example 2 shows a crystalline silicon (c-Si) phase and lithium silicate (LizSiO₃) phase. In addition, in the case of the lithium-doped silicon oxide anode active material containing a Ti—Si alloy according to each of Examples 1-3, a Ti—Si alloy (C49-TiSi₂, C54-ATiSi₂) phase also appears, besides the crystalline silicon (c-Si) phase and lithium silicate (LizSiO₃) phase.

### Test Example 2

### Quantitative Analysis

The anode active material according to each of Examples 1 and 2 and Comparative Example 2 was quantitively analyzed in terms of crystalline silicon (c-Si) content, lithium silicate (Li₂SiO₃) content and Ti—Si alloy (C49-TiSi₂, C54-ATiSi₂) content by using the Rietveld method.

The results are shown in the following Table 1.

TABLE 1

| | c-Si | Li₂SiO₃ | C54—TiSi₂ | C49—TiSi₂ |
|---|---|---|---|---|
| | content | content | content | content |
| | (wt %) | (wt %) | (wt %) | (wt %) |
| Ex. 1 | 28.1 | 69.3 | 1.8 | 0.8 |
| Ex. 2 | 24.9 | 69.1 | 4.0 | 2.0 |
| Comp. Ex. 2 | 30.4 | 69.6 | — | — |

### Test Example 3

### Scanning Electron Microscopy (SEM), Transmission Electron Microscopy (TEM) and Energy Dispersive Spectroscopy (EDS)

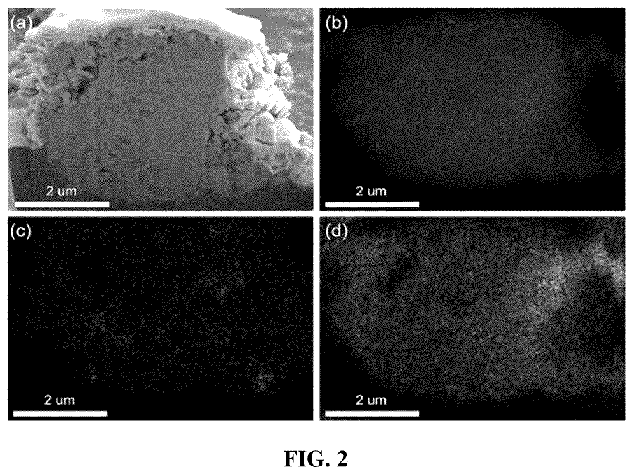

The section of the anode active material according to each of Examples 1 and 2 and Comparative Examples 1 and 2 was analyzed through scanning electron microscopy (SEM). The results are shown in FIG. 2.

FIG. 2 shows a scanning electron microscopic (SEM) image (a) of the section of the anode active material according to Example 1, and energy dispersive spectroscopic (EDS) image of Si (b), Ti (c) and O (d) elements.

Referring to FIG. 2, it can be seen that the anode active material according to the present disclosure has pores formed therein, and Ti elements are distributed homogeneously therein.

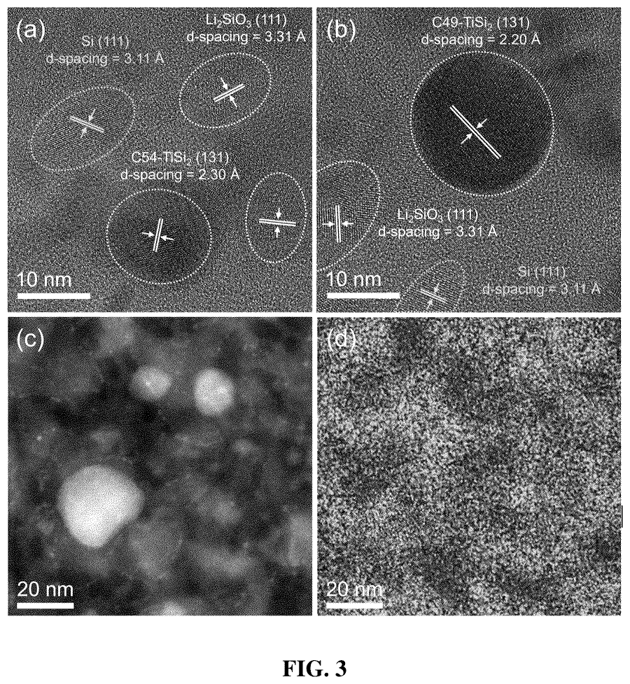

FIG. 3 shows a high-resolution transmission electron microscopic (HRTEM) images (a, b) of the anode active material according to Example 1, scanning transmission electron microscopic (STEM) image (c) thereof, and an energy dispersive spectroscopic (EDS) image (d) of Si (blue), Ti (red) and O (green) elements.

Referring to FIG. 3, it can be seen that the transition metal-silicon alloy in the anode active material according to the present disclosure is not simply mixed with lithium silicate but is present inside the structure of lithium silicate.

### Test Example 4

### Nitrogen Gas Adsorption Test

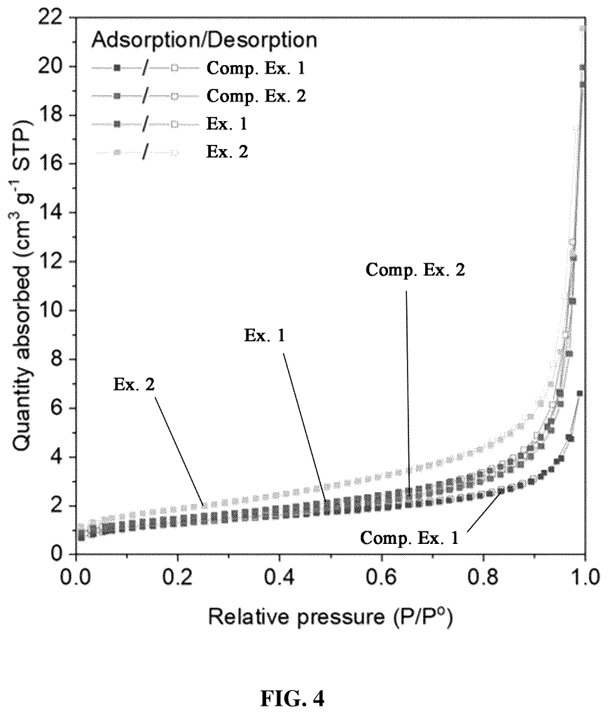

To determine the specific surface area and porosity of the anode active material according to each of Examples 1 and 2 and Comparative Examples 1 and 2, a gas adsorption test was carried out. The results are shown in FIG. 4 and the following Table 2.

FIG. 4 shows the nitrogen gas adsorption test results of the anode active materials according to Examples 1 and 2 and Comparative Examples 1 and 2.

TABLE 2

| | BET surface area (m² g⁻¹) | Pore volume (cm³ g⁻¹) |
|---|---|---|
| Ex. 1 | 5.23 | 0.0306 |
| Ex. 2 | 6.69 | 0.0330 |
| Comp. Ex. 1 | 4.53 | 0.0095 |
| Comp. Ex. 2 | 4.69 | 0.0296 |

As shown in FIG. 4 and Table 2, the anode active materials of Examples 1 and 2 according to the present disclosure have a larger specific surface area and higher porosity, as compared to Comparative Examples 1 and 2 containing silicon oxide or lithium silicate.

### Test Example 5

### Evaluation of Electrochemical Properties

The anode active material according to each of Examples and Comparative Examples, Super-P as a conductive material and polyacrylic acid (PAA) as a binder were mixed with ultrapure water at a weight ratio of 80:10:10 to prepare a slurry-like composition. The composition was applied to copper foil having a thickness of 10 um and vacuum dried at 100° C. for 2 hours to obtain an anode. The resultant anode was used together with lithium metal as a counter electrode, a polyethylene separator was interposed between the anode and the counter electrode, and then an electrolyte including 1.0 M LiPF₆ in ethylene carbonate: ethyl methyl carbonate: diethyl carbonate (EC:EMC:DEC) (2:2:5 vol %) and 10 vol % of fluoroethylene carbonate (FEC) additive mixed therewith was injected thereto to assemble a CR2032 coin cell. The assembled coin cell was allowed to stand at room temperature for 12 hours to obtain a half-cell.

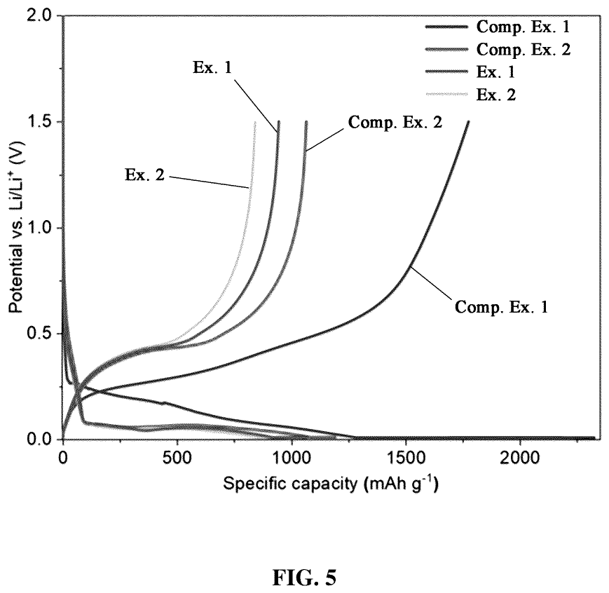

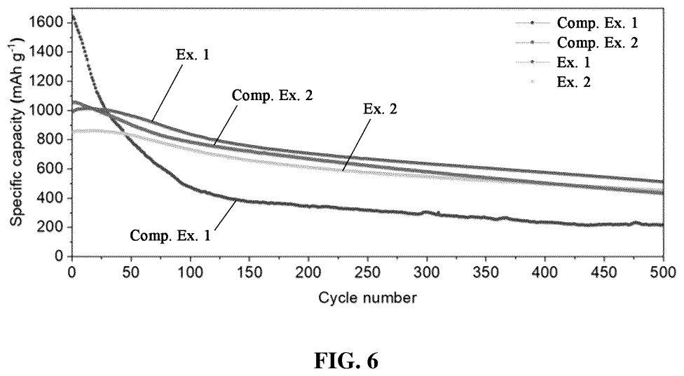

The secondary battery using the anode active material according to each of Examples 1 and 2 and Comparative Examples 1 and 2 was charged in a constant current mode at room temperature (25° C.) at a current density of 50 mAg⁻¹ until the voltage reached 0.01 V (vs. Li), and then charged in a constant voltage mode while maintaining 0.01 V with a cut-off current of 10 mAg⁻¹. Then, the battery was discharged in a constant current mode at 50 mAg⁻¹ until the voltage reached 1.5 V (vs. Li). Such a charge/discharge cycle was taken as 1 cycle, and 2 charge/discharge cycles were further carried out in the same manner as described above. Then, application of current density during charge/discharge was changed to 500 mAg⁻¹, and 500 cycles were further carried out to evaluate electrochemical characteristics. The results are shown in FIG. 5, FIG. 6 and the following Table 3.

FIG. 5 shows the charge/discharge voltage curve of a secondary battery using the anode active material according to each of Examples 1 and 2 and Comparative Examples 1 and 2.

FIG. 6 shows a graph illustrating the discharge life characteristics of a secondary battery using the anode active material according to each of Examples 1 and 2 and Comparative Examples 1 and 2 after the 500^{th} cycle.

TABLE 3

| | Charge | Discharge | Initial | Discharge capacity |
|---|---|---|---|---|
| | capacity | capacity | efficiency | retention |
| | (mAh g⁻¹) | (mAh g⁻¹) | (%) | (@500 cycle, %) |
| Ex. 1 | 1067 | 944 | 88.50 | 51.57 |
| Ex. 2 | 949 | 840 | 88.50 | 53.23 |
| Comp. Ex. 1 | 2323 | 1774 | 76.34 | 13.20 |
| Comp. Ex. 2 | 1191 | 1064 | 89.36 | 41.07 |

As shown in FIG. 5, FIG. 6 and Table 3, the secondary battery using the silicon oxide anode active material shows a significantly low level of discharge capacity retention of 13.20% after the 500^{th} cycle. As compared to this, in the case of Comparative Example 2 including lithium silicate, it shows a slightly increased discharge capacity retention. On the contrary, the secondary battery using each of Examples 1 and 2 as the anode active material including lithium silicate and a titanium-silicon alloy according to the present disclosure shows a discharge capacity retention increased by approximately 4 times as compared to Comparative Example 1, and thus provides a significantly improved discharge capacity retention.

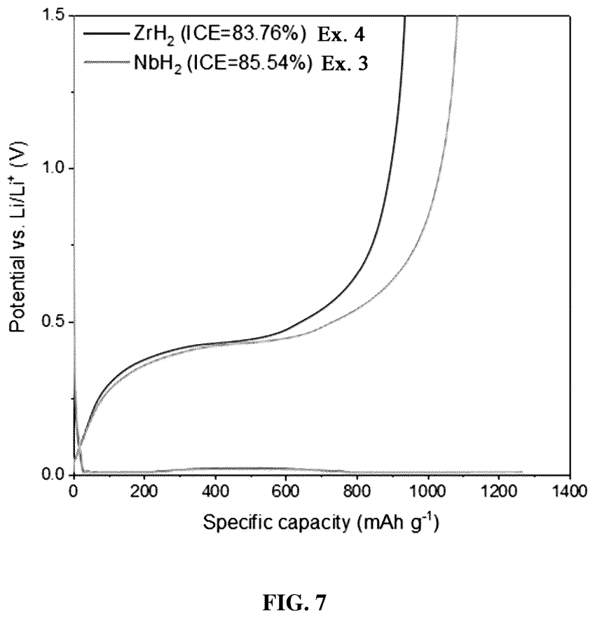

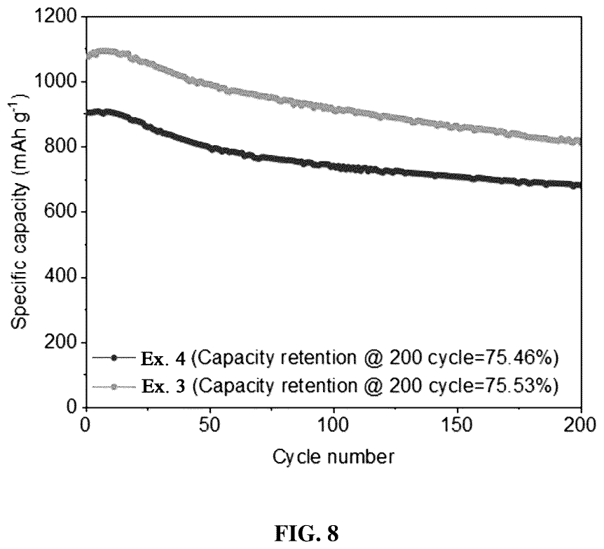

Meanwhile, the electrochemical characteristics of the secondary battery using the anode active material according to each of Examples 3 and 4 were evaluated for 200 cycles in the same manner as described above. The results of discharge life characteristics are shown in FIG. 7, FIG. 8 and the following Table 4.

TABLE 4

| | Charge | Discharge | Initial | Discharge capacity |
|---|---|---|---|---|
| | capacity | capacity | efficiency | retention |
| | (mAh g⁻¹) | (mAh g⁻¹) | (%) | (@200 cycle, %) |
| Ex. 3 (ZrH₂) | 1117 | 935 | 83.76 | 75.46 |
| Ex. 4 (NbH₂) | 1266 | 1083 | 85.54 | 75.53 |

FIG. 7 shows the charge/discharge voltage curve of a secondary battery using the anode active material according to each of Examples 3 and 4.

FIG. 8 shows a graph illustrating the discharge life characteristics of a secondary battery using the anode active material according to each of Examples 3 and 4 after the 200^{th} cycle.

As shown in FIG. 7, FIG. 8 and Table 4, it can be seen that the secondary battery using the anode active material including a transition metal-silicon alloy and lithium silicate according to the present disclosure shows an excellent discharge capacity retention.

In a battery, the discharge capacity retention is a factor determining how long the designed capacity can be maintained, and is the most important factor as compared to the charge capacity, discharge capacity, and initial efficiency in designing a battery and evaluating the performance thereof. It can be confirmed from the results of Test Example 5 that the anode active material according to the present disclosure can provide a remarkably improved discharge capacity retention, while maintaining charge capacity, discharge capacity, and initial efficiency at an excellent level.

### Test Example 6

### Evaluation of High-Rate Characteristics

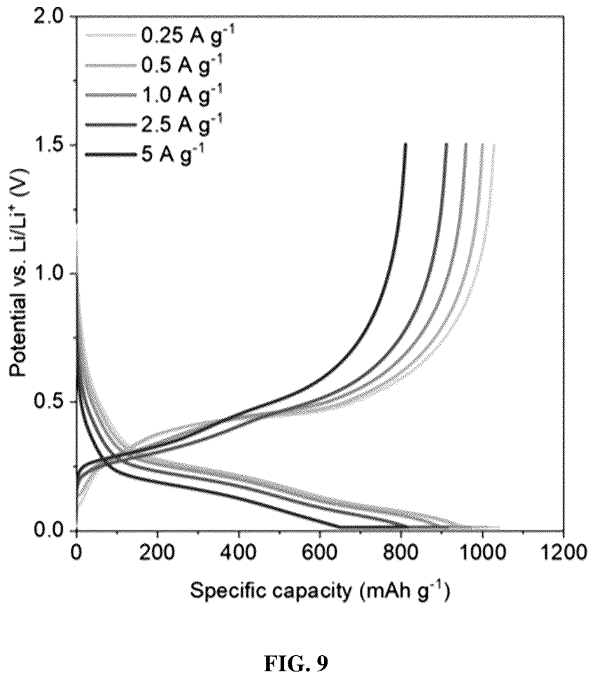

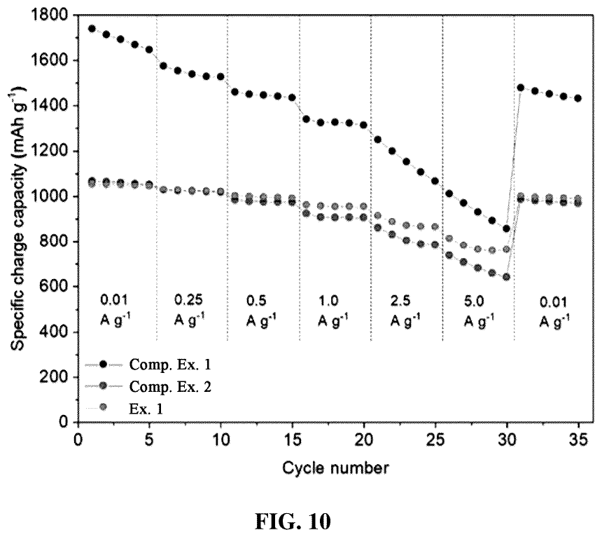

The secondary battery using the anode active material according to each of Examples 1 and 2 and Comparative Examples 1 and 2 was subjected to 3 formation cycles in the same manner as Test Example 4, charged in a constant current mode at a different current density (0.25 Ag⁻¹, 0.5 Ag⁻¹, 1 Ag⁻¹, 2.5 Ag⁻¹ and 5 Ag⁻¹) and then charged in a constant voltage mode while maintaining 0.01 V with a cut-off current density of 1/10 of drift current density. Then, the battery was discharged in a constant current mode until the voltage reached 1.5 V (vs. Li). Such a charge/discharge cycle was taken as 1 cycle, and 5 cycles were carried out in the same manner as described above. The results are shown in FIG. 9 and FIG. 10.

FIG. 9 shows the charge/discharge voltage curve of a secondary battery using the anode active material according to Example 1 as a function of current density.

FIG. 10 shows a graph illustrating the high-rate characteristics of a secondary battery using the anode active material according to each of Example 1 and Comparative Examples 1 and 2.

Referring to FIG. 9 and FIG. 10, it can be seen that the secondary battery using the anode active material of each of Examples 1 according to the present disclosure realizes a capacity at a level similar to the initial capacity even at a high rate of 5.0 A/g, thereby providing excellent high-rate characteristics. On the contrary, in the case of the secondary battery using the anode active material according to each of Comparative Examples 1 and 2, it shows a rapid drop in capacity under the condition of a high rate as compared to the initial capacity.

In general, a battery undergoes degradation of charge/discharge characteristics under the condition of a high rate. However, it is shown that the anode active material according to the present disclosure retains a high level of capacity even at a high rate, and thus improves the phenomenon of charge/discharge efficiency degradation.

### Test Example 7

### Evaluation of Thermal Stability

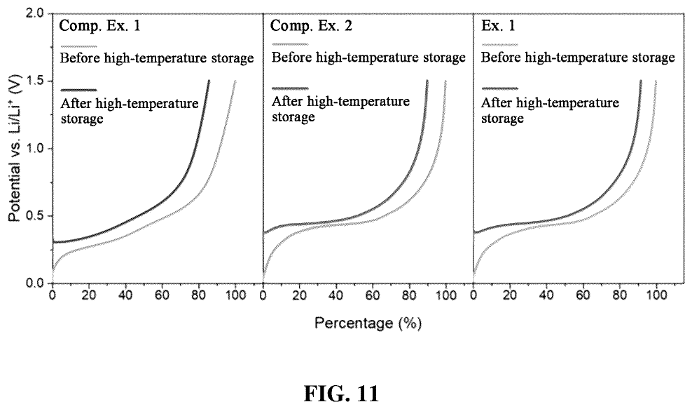

The secondary battery using the anode active material according to each of Examples 1 and 2 and Comparative Examples 1 and 2 was subjected to 3 formation cycles in the same manner as Test Example 4, and charged to a fully charged state. Then, the fully charged half-cell was stored at a high temperature of 85° C. in a thermo-hygrostat. Then, the half-cell was recovered from the thermo-hygrostat after 48 hours, allowed to stand for 3 hours until the temperature of the half-cell was stabilized at room temperature (25° C.), and discharged in a constant current mode at 500 mAg⁻¹ until the voltage reached 1.5 V (vs. Li) to determine the discharge capacity retention based on the discharge capacity before the high-temperature storage. In this manner, the half-cell was evaluated in terms of a drop in discharge capacity caused by self-discharge during the high-temperature storage. The results are shown in FIG. 11 and the following Table 4.

FIG. 11 shows the charge/discharge voltage curve of a secondary battery using the anode active material according to each of Example 1 and Comparative Examples 1 and 2, before and after storing the battery at high temperature.

TABLE 5

| | Discharge | Discharge | Discharge capacity |
|---|---|---|---|
| | capacity before | capacity after | retention after |
| | high-temperature | high-temperature | high-temperature |
| | storage (mAh g⁻¹) | storage (mAh g⁻¹) | storage (%) |
| Ex. 1 | 981 | 901 | 91.84 |
| Comp. Ex. 1 | 1562 | 1339 | 85.73 |
| Comp. Ex. 2 | 1056 | 951 | 90.01 |

Referring to FIG. 11 and Table 5, in the case of the secondary battery using the anode active material according to Comparative Example 1, it shows a poor level of thermal stability as determined by a discharge capacity retention of 85.73% after high-temperature storage based on discharge capacity retention before high-temperature storage. As compared to this, the secondary battery using Comparative Example 2 shows an increase in discharge capacity retention after high-temperature storage. In addition, the secondary battery using the anode active material of Example 1 according to the present disclosure shows a slight increase in discharge capacity retention of about 1.83% after high-temperature storage, as compared to Comparative Example 2. The above results are obtained under the high-temperature storage test condition for 48 hours, and the difference in discharge capacity retention after high-temperature storage becomes clearer, as the high-temperature storage time is increased. Therefore, it can be seen from Table 4 that the difference in discharge capacity retention after high-temperature storage between Example 1 and Comparative Example 2 is significant.

In general, a lithium secondary battery is liable to high temperature. Therefore, when a lithium secondary battery is operated at high temperature, it shows a safety-related problem and capacity degradation to cause degradation of life, which is a factor limiting the scope of utilization of the lithium secondary battery. However, the anode active material according to the present disclosure shows low reactivity with an electrolyte even at high temperature and significantly improves a phenomenon of capacity degradation after high-temperature storage, thereby allowing the use of a lithium secondary battery using the same even under high temperature environment.

1. An anode active material comprising:
silicon;
lithium silicate; and
a transition metal-silicon alloy.

2. The anode active material according to claim 1, wherein the transition metal-silicon alloy is present inside the lithium silicate.

3. The anode active material according to claim 1, wherein the lithium silicate comprises at least one of Li₂Si₂O₅, LizSiO₃ and LigSiO₄.

4. The anode active material according to claim 1, wherein the lithium silicate is present in an amount of 65-75 wt % based on 100 wt % of the total weight of the anode active material.

5. The anode active material according to claim 1, wherein the transition metal comprises at least one selected from titanium (Ti), iron (Fe), manganese (Mn), nickel (Ni), cobalt (Co), niobium (Nb), zirconium (Zr) and copper (Cu).

6. The anode active material according to claim 1, wherein the transition metal-silicon alloy is present in an amount of 1.6-10 wt % based on 100 wt % of the total weight of the anode active material.

7. The anode active material according to claim 1, which has a specific surface area of 4.85-6.69 m²g⁻¹ and a porosity of 0.0302-0.0330 cm³g⁻¹.

8. An anode comprising the anode active material as defined in claim 1.

9. A lithium secondary battery comprising the anode as defined in claim 8.

10. A method for preparing an anode active material, comprising the steps of:
(i) mixing silicon monoxide with a transition metal precursor;
(ii) heat treating the mixture obtained from step (i) to obtain a transition metal-silicon alloy; and
(iii) mixing the mixture obtained from step (ii) with a lithium precursor and carrying out heat treatment to obtain lithium silicate.

11. The method for preparing an anode active material according to claim 10,
wherein the transition metal precursor comprises at least one of transition metal hydrides and transition metal hydroxides, and
the transition metal is at least one selected from titanium (Ti), iron (Fe), manganese (Mn), nickel (Ni), cobalt (Co), niobium (Nb), zirconium (Zr) and copper (Cu).

12. The method for preparing an anode active material according to claim 10, wherein the transition metal precursor and silicon monoxide are mixed in such a manner that the molar ratio of the transition metal to silicon may be 0.02-1.

13. The method for preparing an anode active material according to claim 10, wherein the mixing in step (i) is ball milling and is carried out at a rate of 500-1000 rpm for 4-12 hours.

14. The method for preparing an anode active material according to claim 10, wherein the heat treatment in step (ii) is carried out at 500-1200° C. for 5 minutes to 3 hours.

15. The method for preparing an anode active material according to claim 10, wherein the lithium precursor is at least one selected from lithium (Li), lithium hydride (LiH) and lithium hydroxide (LiOH).

16. The method for preparing an anode active material according to claim 10, wherein the mixture obtained from step (ii) and the lithium precursor are mixed in such a manner that the molar ratio (Li/Si) of lithium to silicon may be 0.3-1.

17. The method for preparing an anode active material according to claim 10, wherein the heat treatment in step (iii) is carried out at 600-1000° C. for 1-12 hours.

18. The method for preparing an anode active material according to claim 10, wherein the transition metal-silicon alloy is present in an amount of 1.6-10 wt % based on 100 wt % of the total weight of the anode active material.

19. The method for preparing an anode active material according to claim 10, wherein the lithium silicate is present in an amount of 65-75 wt % based on 100 wt % of the total weight of the anode active material.

20. The method for preparing an anode active material according to claim 10, wherein the anode active material has a specific surface area of 4.85-6.69 m²g⁻¹ and a porosity of 0.0302-0.0330 cm³g⁻¹.
